(19) United States
(12) Patent Application Publication
(10) Pub. No.: US 2024/0250279 A1
(43) Pub. Date: Jul. 25, 2024

(54) ELECTROCHEMICAL CELL AND METHOD FOR PRODUCING AN ELECTROCHEMICAL CELL

(71) Applicant: Robert Bosch GmbH, Stuttgart (DE)

(72) Inventor: Michael Raedler, Hamburg (DE)

(21) Appl. No.: 18/561,636

(22) PCT Filed: Apr. 21, 2022
(86) PCT No.: PCT/EP2022/060488

§ 371 Date: Nov. 16, 2023

(30) Foreign Application Priority Data
May 18, 2021 (DE) 10 2021 205 008.5

(51) Int. Cl. H01M 8/0284; H01M 8/0286; H01M 8/1004

(52) U.S. Cl. CPC H01M 8/0284; H01M 8/0286; H01M 8/1004

(57) ABSTRACT

The invention relates to an electrochemical cell (100) having a membrane-electrode assembly (1) and a distributor plate (7, 8), the membrane-electrode assembly (1) and the distributor plate (7, 8) forming an electrode chamber (100a, 100b). The membrane-electrode assembly (1) has a frame structure (16), the frame structure (16) and the distribution plate (7, 8) being connected to one another by means of a bonded connection. The bonded connection has a first silicone seal and a second silicone seal.

### BACKGROUND

The present invention relates to an electrochemical cell, in particular a PEM fuel cell, and a method for producing an electrochemical cell.

Electrochemical cells, in particular fuel cells, with membrane-electrode assemblies and bipolar plates are known in the prior art, for example from the patent application DE102015218117A1. The membrane-electrode assemblies usually comprise a membrane and one electrode layer each on both sides of the membrane, optionally also diffusion layers, as known from DE10140684A1, for example. The membrane and the electrode layers are circumferentially surrounded by a frame structure, often referred to here as a sub-gasket. The electrode layer comprises a very expensive catalyst, usually platinum.

The membrane-electrode assembly and bipolar plate can interact in a sealing manner, for example as known from EP1453133B1. The object of the present invention is to provide a reliable bonded sealing connection between the membrane-electrode assembly and the bipolar plate or distributor plate.

### SUMMARY

To this end, the electrochemical cell comprises a membrane-electrode assembly and a distributor plate. The membrane-electrode assembly and the distributor plate form an electrode chamber. The membrane-electrode assembly has a frame structure, wherein the frame structure and the distributor plate are connected by means of a bonded connection. The bonded connection has a first silicone seal and a second silicone seal.

The electrochemical cell does not necessarily have to be a functional cell, but can initially only be a composite of a distribution plate with a membrane-electrode assembly. Functionality is then established by stacking multiple such electrochemical cells, in particular when two distributor plates are combined to form a bipolar plate and one bipolar plate is connected to each membrane-electrode assembly.

The bonded connection consisting of the two silicone seals has a number of advantages for the electrochemical cell: Robustness against oxygen, hydrogen, and coolant media as well as against demineralized water, and reliable sealing action over the entire service life. Due to the robustness against said media, the electrochemical cell is preferably configured as a fuel cell or an electrolysis cell. Due to the robustness against demineralized water, the electrochemical cell is particularly preferably configured as a fuel cell.

The invention also includes a corresponding production process for establishing a bonded connection between the distributor plate and the membrane-electrode assembly. The bonded connection is advantageously attached to a frame structure of the membrane-electrode assembly, but equivalently it can also be attached to other areas of the membrane-electrode assembly, provided that the adhesion of the silicone and the sealing function are given.

The method for producing an electrochemical cell having a bonded connection between the membrane-electrode assembly and the distribution plate comprises the following method steps:
Applying a first silicone seal to the distributor plate
Applying a second silicone seal to the membrane electrode assembly, in particular to the frame structure
Treating at least one of the two silicone seals with oxygen plasma
Joining the two silicone seals together to form the bonded connection.

By treating with oxygen plasma, at least one of the two silicone seals is activated. Accordingly, the bonded connection between the two silicone seals can be established when they are subsequently joined together. In advantageous embodiments, joining is carried out by temporary pressing. The chemical and/or adhesive connections between the two silicone seals are thereby enhanced.

Silicone seals are preferably applied using template pressure or time-pressure dispensing. These methods represent the best solutions in terms of cycle times and tolerances.

In advantageous embodiments of the method, the silicone seal that is not treated with oxygen plasma is cured before joining. Thermal curing is preferably carried out, for example using a thermal source such as UV light. However, both silicone seals can also be treated with oxygen plasma; in this case, curing prior to joining is advantageously omitted.

In addition to the fuel cell, the invention also relates to other electrochemical cells, such as battery cells and electrolysis cells, in particular if silicone acts as a very robust sealing with respect to the media used therein.

Further measures improving the invention arise from the following description of a few embodiment examples of the invention, which are schematically represented in the figures. All of the features and/or advantages arising from the claims, description, or drawings, including structural details, spatial arrangements, and method steps, can be essential to the invention both by themselves and in the various combinations. It should be noted that the figures have only a descriptive character and are not intended to limit the invention in any way.

### BRIEF DESCRIPTION OF THE DRAWINGS

The following are shown schematically:

FIG. 1 the section through a fuel cell known from the prior art, wherein only the essential regions are shown,

FIG. 2 a section through a membrane-electrode assembly with a frame structure from the prior art, wherein only the essential regions are shown,

FIG. 3 a section through an electrochemical cell according to the invention with a membrane-electrode assembly and a distributor plate, wherein only the essential regions are shown,

FIG. 4 a sketched method for producing a bonded connection between a distributor plate and a membrane-electrode assembly, wherein only the essential steps are shown.

### DETAILED DESCRIPTION

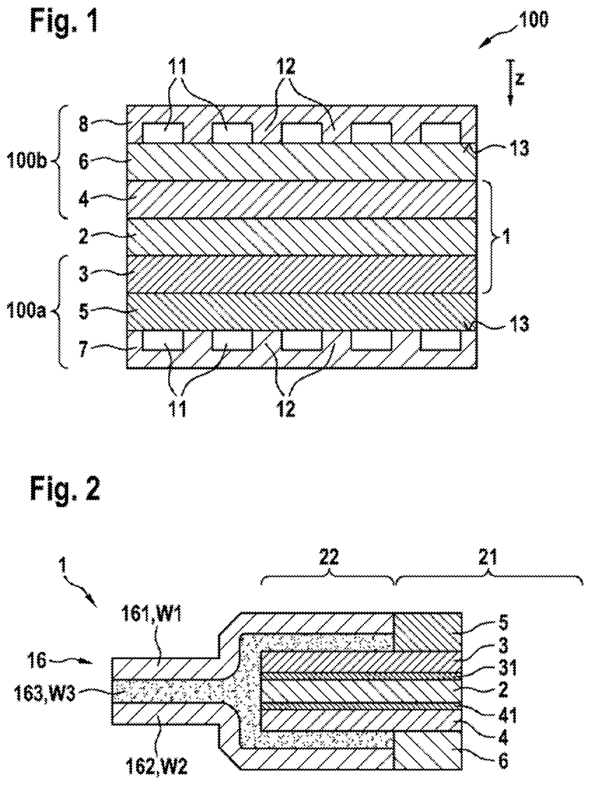

FIG. 1 schematically shows an electrochemical cell 100 known from the prior art in the form of a fuel cell, wherein only the essential regions are shown. The fuel cell 100 comprises a membrane 2, in particular a polymer electrolyte membrane. To one side of the membrane 2 a cathode space 100a is formed, to the other side an anode space 100b.

In the cathode space 100a, outwardly facing from the membrane 2—therefore in the normal direction or stacking direction z—an electrode layer 3, a diffusion layer 5, and a distributor plate 7 are arranged. Analogously, an electrode layer 4, a diffusion layer 6, and a distributor plate 8 are arranged in the anode space 100b facing outwardly from the membrane 2. The membrane 2 and the two electrode layers 3, 4 form a membrane-electrode assembly 1. Optionally, the two diffusion layers 5, 6 can also be a component of the membrane-electrode assembly 1. Optionally, one or both diffusion layers 5, 6 can also be eliminated, provided that the distributor plates 7, 8 can provide sufficiently homogeneous gas feeds.

The distributor plates 7, 8 have channels 11 for the gas supply—for example air in the cathode space 100a and hydrogen in the anode space 100b—to the gas diffusion layers 5, 6. The diffusion layers 5, 6 typically consist of a carbon fiber fleece on the channel side—i.e., towards the distributor plates 7, 8—and a microporous particle layer on the electrode side—i.e., towards the electrode layers 3, 4.

The distributor plates 7, 8 comprise the channels 11 and thus implicitly also connecting portions 12 adjacent to the channels 11. The undersides of these connecting portions 12 thus form a contact surface 13 of the respective distributor plate 7, 8 to the underlying diffusion layer 5, 6.

Usually, the cathode-side distributor plate 7 of an electrochemical cell 100 and the anode-side distributor plate 8 of the electrochemical cell adjacent thereto are fixedly connected, for example by welded connections, and thus combined into a bipolar plate.

FIG. 2 shows a vertical section of the membrane-electrode assembly 1 of an electrochemical cell 100, in particular of a fuel cell, in an edge region, wherein only the essential regions are shown. The membrane-electrode assembly 1 has the membrane 2, by way of example a polymer electrolyte membrane (PEM), and two porous electrode layers 3 and 4 each having a catalyst layer, wherein the electrode layers 3 and 4 are each arranged on one side or surface of the membrane 2. The electrochemical cell 100 further comprises the two gas diffusion layers 5 and 6 which, depending on the embodiment, can also belong to the membrane electrode assembly 1.

The membrane electrode assembly 1 is circumferentially surrounded by the frame structure 16, which in the present context is also referred to as a subgasket. The frame structure 16 is used to provide stiffness and tightness to the membrane electrode assembly 1 and is a non-active area of the electrochemical cell 100.

The frame structure 16 is in particular designed to be U-shaped or Y-shaped in section, a first leg of the U-shaped frame portion being formed by a first film 161 made of a first material W1, and a second leg of the U-shaped frame portion being formed by a second film 162 made of a second material W2. In addition, the first film 161 and the second film 162 are adhered together by means of an adhesive 163 made of a third material W3. The first material W1 and the second material W2 are often identical and made of a thermoplastic polymer, e.g., PEN (polyethylene naphthalate).

The two gas diffusion layers 5 or 6 are basically inserted into the frame structure 16, conventionally such that they are each in contact with one electrode layer 3, 4 via an active surface 21 of the membrane-electrode assembly 1. The electrode layers 3, 4 comprise a catalyst paste 31, 41 in which catalysts, typically catalyst particles, are embedded.

If the electrode layers 3, 4 are covered by the frame structure 16, it is a non-active edge region 22 of the membrane-electrode assembly 1. In the non-active edge region 22, no reaction fluids reach the electrode layers 3, 4 or catalytic pastes 31, 41 of the embedded catalysts; thus, chemical reactions do not take place in the edge region 22, the current density of the electrochemical cell 100 thus drops very sharply relative to the active surface 21 or is even zero.

A sealing concept for an electrochemical cell 100 provides that the frame structure 16 of the membrane electrode assembly 1 and the distribution plates 7, 8 or bipolar plates interact in a sealing manner such that cathode chamber 100a and anode chamber 100b are sealed off from the environment, for example as known from EP1453133B1.

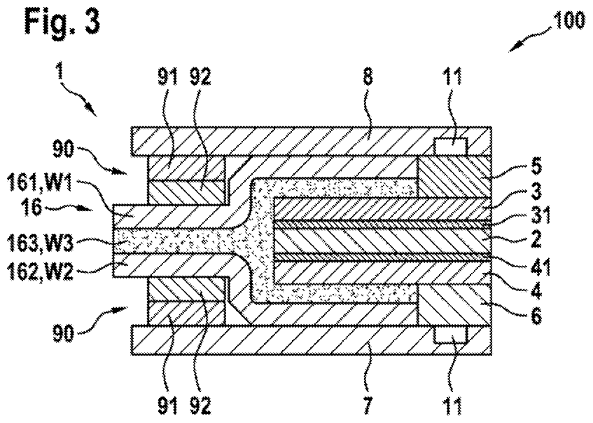

According to the invention, an improved sealing concept is now provided. For this purpose, FIG. 3 exemplarily shows the section of an electrochemical cell 100 in a vertical section. The electrochemical cell 100, in particular designed as a fuel cell, comprises a membrane electrode assembly 1 and two distribution plates 7, 8, as already presented in FIGS. 1 and 2. According to the invention, the frame structure 16 of the membrane-electrode assembly 1 is now connected to a distribution plate 7, 8 by means of a bonded connection 90, wherein the bonded connection 90 comprises a first silicone seal 91 and a second silicone seal 92.

Both distribution plates 7, 8 can be connected to the membrane-electrode assembly 1 with a bonded connection 90, as shown in FIG. 3, or only one of the distribution plates 7, 8. The silicone seals 91, 92 of the bonded connection comprise a silicone adhesive. Preferably, the silicone seals 91, 92 or one of the two silicone seals 91, 92 are activated with an oxygen plasma. Furthermore, the bonded connection of the distribution plate 7, 8 to the membrane-electrode assembly 1 is achieved by temporary pressing.

The active surface of the electrochemical cell 100 is sealed by the bonded connection 90, more specifically, the cathode chamber 100a and anode chamber 100b respectively are sealed off from the outside so that no media can penetrate to the outside. In particular when using media such as hydrogen, the sealing function also has a high importance with regard to safety against ignition, explosions, etc.

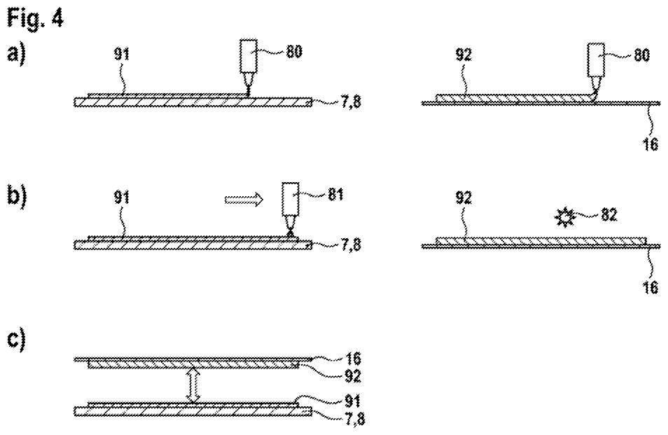

FIG. 4 outlines a method for the bonded connection of a distributor plate 7, 8 to a membrane-electrode assembly 1.

In FIG. 4a, the first silicone seal 91 is applied to the distributor plate 7, 8 by means of an application device 80, and the second silicone seal 92 is applied to the membrane-electrode assembly 1 or to the frame structure 16 of the membrane-electrode assembly 1. Silicone seals 91, 92 are preferably applied using template pressure or time-pressure dispensing.

In the embodiment of FIG. 4—see FIG. 4b—the second silicone seal 92 is subsequently cured, for example thermally, by acetic acid debonding or by UV light. A thermal source 82 is shown as an example. The first silicone seal 91 is treated with oxygen plasma by means of an oxygen plasma device 81. This may be both atmospheric pressure plasma as well as low pressure plasma. This activates the first silicone seal 91.

In alternative methods, the first silicone seal 91 may also be cured and the second silicone seal 92 treated with oxygen plasma and thereby activated. Furthermore, it is also possible for both silicone seals 91, 92 to be treated and activated with oxygen plasma.

FIG. 4c shows the subsequent joining of the two distributor plate 7, 8 and membrane-electrode assembly 1 components to each other by joining the two silicone seals 91, 92. This is preferably carried out by temporary pressing of the two components together.

As a result, the electrochemical cell 100 thus created comprises a bonded connection 90 between the membrane-electrode assembly 1 and the distribution plate 7, 8. The bonded connection 90 fulfills a reliable sealing function that is resistant to the media hydrogen, oxygen, and coolants as well as to demineralized water over a long period of time. Accordingly, such a bonded compound 90 is particularly well suited for electrochemical cells 100 configured as fuel cells or electrolysis cells.

1. An electrochemical cell (100) having a membrane-electrode assembly (1) and a distribution plate (7, 8), the membrane-electrode assembly (1) and the distribution plate (7, 8) forming an electrode chamber (100a, 100b), wherein the membrane-electrode assembly (1) has a frame structure (16), the frame structure (16) and the distribution plate (7, 8) being connected to one another by a bonded connection (90), wherein the bonded connection (90) has a first silicone seal (91) and a second silicone seal (92).

2. A method for producing an electrochemical cell (100) having a membrane-electrode assembly (1) and a distribution plate (7, 8), the membrane-electrode assembly (1) and the distribution plate (7, 8) forming an electrode chamber (100a, 100b), wherein the membrane-electrode assembly (1) has a frame structure (16), the frame structure (16) and the distribution plate (7, 8) being connected to one another by a bonded connection (90) by the following process steps:
a) Applying a first silicone seal (91) to the distributor plate (7, 8)
b) Applying a second silicone seal (92) to the membrane electrode assembly (1)
c) Treating at least one of the two silicone seals (91, 92) with oxygen plasma
d) Joining the two silicone seals (91, 92) together to form the bonded connection (90).

3. The method according to claim 2, wherein prior to joining, the silicone seal (91, 92) that is not treated with oxygen plasma is cured.

4. The method according to claim 2, wherein the two silicone seals (91, 92) are joined together by temporary pressing.

5. The method according to claim 2, wherein the two silicone seals (91, 92) are applied by template pressure or time-pressure dispensing.

6. The method according to claim 2, wherein applying the second silicone seal (92) to the membrane electrode assembly (1) includes applying the second silicone seal (92) to the frame structure (16).

7. The method according to claim 3, wherein the curing is carried out using a thermal source (82).
